(19) United States
(12) Patent Application Publication
(10) Pub. No.: US 2015/0274236 A1
(43) Pub. Date: Oct. 1, 2015

(54) BICYCLE PROVIDED WITH A REFLECTIVE SURFACE AND USE OF A REFLECTIVE SURFACE

(71) Applicant: OSMANA, Besloten Vennootschap met Beperkte, Olen (BE)

(72) Inventor: Jan Oeyen, Olen (BE)

(21) Appl. No.: 14/431,459

(22) PCT Filed: Oct. 7, 2013
(86) PCT No.: PCT/BE2013/000054

§ 371 Date: Mar. 26, 2015

(30) Foreign Application Priority Data
Oct. 11, 2012 (BE) 2012/0684

(51) Int. Cl. B62J 29/00; B62K 3/00

(52) U.S. Cl. CPC B62J 29/00; B62K 3/00

(57) ABSTRACT

Bicycle (1) provided with a saddle (2) and a reflective surface (12) that enables a user of the bicycle (1) to look backwards or forwards, characterised in that the reflective surface (12) is affixed in such a location on the bicycle (1) that it is lower than the highest point of the saddle (5).

The present invention relates to a bicycle provided with a reflective surface and the use of a reflective surface.

When using a bicycle it can be desirable or necessary to be able to look behind the bicycle, or to be able to look forwards without harming the streamline.

This can be the case, for example, when the cyclist wants to change direction or when he notices that a number of other cyclists or other road users want to overtake him.

This can also be important during a bicycle race, especially during the final sprint, in order to be able to assess the position of other racers.

With regard to looking forward from a position that is ideal from the point of view of the streamline, it is only known to keep the head somewhat raised so that the person can look forwards. However, this presents increased air resistance and can lead to neck complaints, certainly with long and/or multi-day bicycle races.

A view of the situation behind a cyclist can be easily obtained by looking backwards, but this means a risk of undesired deviations from the forward motion and also ensures that the cyclist can no longer keep an eye on the traffic situation.

It is also difficult or impossible to make a powerful cycling movement during such a movement.

Moreover this can be aggravating for the neck and back.

Bicycle racers cycling in a competition often also wear a helmet whose form is optimised for flow from the front, while in another orientation of the head the helmet forms an extra large area and thus presents a lot of air resistance.

It is also known to mount mirrors on the handlebars of a bicycle, whereby the mirrors are placed far towards the outside such that the cyclist can see backwards via a sightline along his own upper body.

However, such a mirror also has disadvantages with regard to air resistance and many people find such a mirror visually unattractive.

Moreover, such a mirror is normally mounted at a distance from the handlebars via a bar, which means that it occupies a relatively large space, such that it can disturb the cyclist when manoeuvring the bicycle, for example when placing it in a shed, or can easily be damaged or even broken off by unintended contact with the cyclist or other objects.

The purpose of the present invention is to provide a solution to at least one of the aforementioned and other disadvantages, by providing a bicycle that is provided with a saddle and a reflective surface that enables a user of the bicycle to look backwards or forwards, whereby the reflective surface is affixed in such a location on the bicycle that it is lower than the highest point of the saddle.

This essentially concerns traditional bicycles, i.e. bicycles on which a user has to sit upright or bent forward, thus not a reclining bicycle.

Such a reflective surface does not need to be affixed protruding sideways, or protrudes sideways to a lesser extent, and is lower than a traditional mirror, such that its air resistance is more limited.

This has no effect, or only a limited effect, on the air resistance of a cyclist while he looks, and on the possibility of the cyclist to exert an effective force on the pedals of the bicycle while looking.

This positive effect on the air resistance is even greater in a preferred embodiment in which the reflective surface, viewed from left to right from the position of a person using the bicycle, is affixed centrally on the bicycle, thus in other words in line with the wheels and the frame of the bicycle, and preferably the reflective surface is narrower than the bar or just as wide as the bar.

As a result the risk of the reflective surface, or its connection to the bicycle, getting in the way of the use of the bicycle and/or jutting out and thereby able to be easily damaged, is greatly reduced.

The user only needs to make a downward or upward movement, and not sideways, of his head to be able to see what is behind him or in front of him respectively. Such a movement is easy to make, even with the eyes alone, especially from the usual bent forward position of a bicycle racer and also has no or only a limited impact on the air resistance.

For looking backwards the reflective surface must have an orientation and position such that from a normal cycling position the cyclist has a sightline backwards that runs via the mirror and via the space between and/or next to the legs of the cyclist.

In a further preferred embodiment the reflective surface is formed by a surface of another component of the bicycle that is made reflective or provided with a reflective surface coating.

As a result the weight and the streamline of the bicycle is not affected or barely affected.

In another preferred embodiment the reflective surface is formed by a mirror that is fastened to the bicycle, whereby the orientation of the reflective surface is adjustable with respect to the bicycle.

In a further preferred embodiment the reflective surface is convex. This enables a small reflective surface, thus with a low weight, low air resistance and a limited impact on the aesthetic design of the bicycle, to be used, but nonetheless enables a large area behind or in front of the cyclist, and partly behind or in front and partly next to the cyclist, to be seen.

In a further preferred embodiment the bicycle is provided with both a reflective surface for looking forwards and one for looking backwards, whereby both reflective surfaces are constructed with the characteristics of a reflective surface mentioned above.

The invention also concerns the use of a reflective surface on a bicycle provided with a saddle whereby the reflective surface is affixed lower than the highest point of the saddle, whereby the user of the bicycle looks forwards or backwards via the reflective surface.

With the intention of better showing the characteristics of the invention, a preferred embodiment of a bicycle according to the invention is described hereinafter by way of an example, without any limiting nature, with reference to the accompanying drawings, wherein:

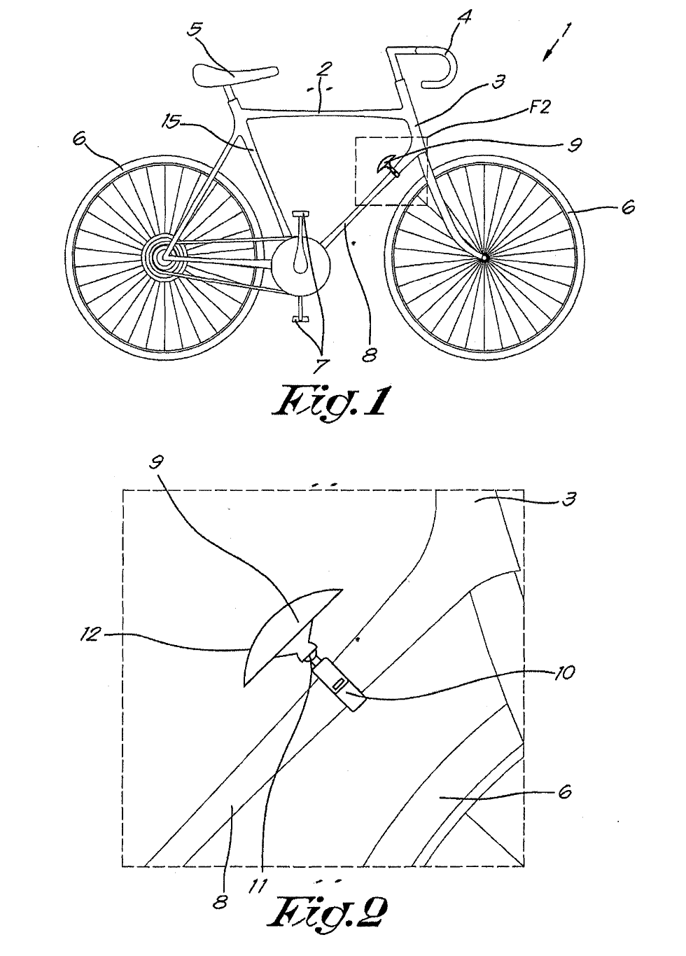

FIG. 1 schematically shows a bicycle according to the invention;

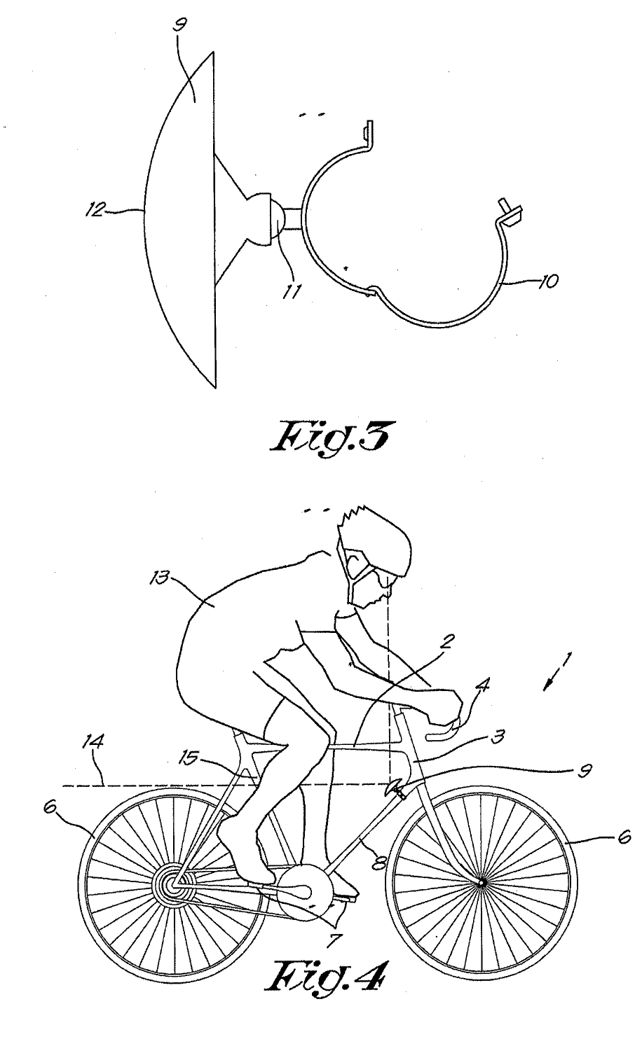

FIG. 2 shows the part of FIG. 1 designated by F2 on a larger scale;

FIG. 3 shows a component of the bicycle of FIG. 1, in a situation in which it is detached from the rest of the bicycle;

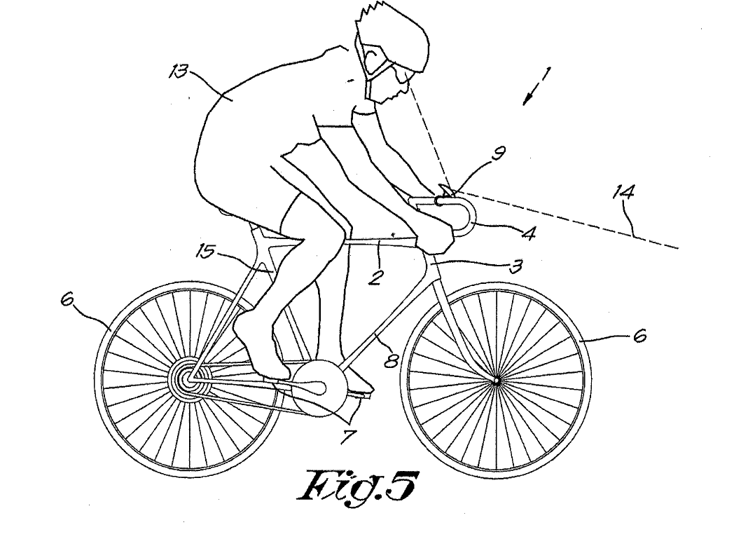

FIG. 4 shows the use of the bicycle of FIG. 1; and

FIG. 5 schematically shows an alternative bicycle according to the invention and the use thereof.

The bicycle 1 shown in FIGS. 1 and 2 comprises a frame 2, with a fork head 3, handlebars 4, a saddle 5, two wheels 6 and two pedals 7.

A mirror 9 is fastened to the sloping bar 8 of the frame 2, i.e. the bar 8 that slopes downwards from front to back, thus from the fork head 3 to the pedals 7.

This mirror 9 is fastened around the sloping bar 8 by means of a clamp 10 secured with a bolt, and thus centrally on the bicycle 1 viewed from left to right. The orientation of the mirror 9 can be adjusted by means of a ball and socket joint 11.

The mirror 9 has a reflective surface 12 that has a convex shape.

As is clear from FIG. 1, the mirror 1 is affixed in a position between the handlebars 4 and the saddle 5, viewed in the direction in which the bicycle is intended to move, thus in front of the saddle 5 and behind the handlebars 4 and lower than the saddle 5, more specifically than the highest point of the saddle.

The use of the bicycle 1 is simple as follows and shown in FIG. 4.

A cyclist 13 who wants to use the bicycle 1 adjusts the orientation of the mirror 9 such that he can look backwards in the desired cycling posture via the mirror 9. He can do this thanks to the ball and socket joint 11.

Hereby he adjusts the mirror such that his view backwards is hampered as little as possible by optional components of the bicycle 1, for example a carrier, or by articles fastened to the bicycle 1, for example a saddlebag under the saddle 5, or a water bottle, that is fastened to the frame 2.

The positioning of the mirror 9 on the frame 2 is such that this is facilitated.

When the cyclist 13 now wants to see what is behind him, or diagonally behind him, while cycling he only has to move his head and eyes somewhat downwards, after which he can observe what is behind him via the reflective surface 12 of the mirror 1 and the space next to and/or behind his legs, for example he can see another cyclist who is trying to pass him. An example of a possible sightline 14 is shown in FIG. 4.

As a result the cyclist thus only needs to make a small movement, he stays sitting in an ideal position on the bicycle 1 and he can quickly look forwards again to react to the traffic situation in front of him.

Alternatively instead of using a mirror 1 to form a reflective surface 12, a part of the bicycle 1, for example a part of the frame 2, can also be made reflective, thus provided with a reflective surface coating.

A mirror 9, or a reflective surface, does not need to be fastened directly to the bicycle 1. For example, when using a holder for a water bottle on the sloping bar 8, the mirror 9 or a reflective surface can be fastened to the holder, or even to the water bottle. In this way a less detrimental aerodynamic effect is obtained.

If a forward view is desirable, the mirror 1 can best be affixed to the bar 15 of the frame 2 below the saddle, to the handlebars, or in the space between the handlebars and the front wheel.

An example of this is shown in FIG. 5. The bicycle 1 shown in this drawing differs from the bicycle 1 described above, because instead of on the frame 2, the mirror 9 is fastened centrally to the handlebars 4 and has an orientation such that the cyclist 13 can look forwards via the mirror 9, even if he is in a position in which he is bent forward to keep the air resistance as low as possible.

Because the mirror 9 is fastened to the handlebars 4, it turns with the handlebars so that the field of view of the user corresponds well with the riding direction.

It should be noted here that in contrast to the bicycle shown in FIGS. 1, 4 and 5, many sports bicycles that are intended for use in a hobby or competition situation generally have handlebars that are mounted lower than the saddle.

On such a bicycle a racing cyclist, when he is in the optimum cycling position, generally has his head at around the level of the saddle, so that a reflective surface mounted on or in front of the handlebars, that can be used to see forwards from such a position, is also lower than the highest point of the saddle.

The present invention is by no means limited to the embodiment and variant described as an example and shown in the drawings, but a bicycle and method according to the invention can be realised in all kinds of forms, dimensions and variants, without departing from the scope of the invention.

1. Bicycle (1) provided with a saddle (2) and a reflective surface (12) that enables a user of the bicycle (1) to look backwards or forwards, characterised in that the reflective surface (12) is affixed in such a location on the bicycle (1) that it is lower than the highest point of the saddle (5).

2. Bicycle (1) according to claim 1, characterised in that it comprises handlebars (4), whereby the reflective surface (12) enables a user of the bicycle (1) to look forwards, whereby the reflective surface (12) is affixed to the handlebars (4).

3. Bicycle (1) according to claim 1, characterised in that the reflective surface (12), viewed from left to right, is affixed centrally on the bicycle (12).

4. Bicycle (1) according to claim 1, characterised in that the reflective surface (12) is convex.

5. Bicycle (1) according to claim 1, characterised in that it is also provided with handlebars (4), and that the reflective surface (12), viewed in the intended riding direction of the bicycle (1), is affixed behind the handlebars (4) and in front of the saddle (5) and is intended for looking backwards.

6. Bicycle (1) according to claim 5, characterised in that the bicycle (1) is provided with a frame (2) with a bar (8) that slopes downwards from front to back and that the reflective surface (12) is affixed to this bar (8).

7. Bicycle (1) according to claim 6, characterised in that the reflective surface (12) is narrower or just as wide as the bar (8).

8. Bicycle according to claim 1, characterised in that the reflective surface (12) is formed by a surface of another component of the bicycle (1) that is made reflective or provided with a reflective surface coating.

9. Bicycle (1) according to claim 1, characterised in that the reflective surface (12) is formed by a mirror (9), whereby the orientation of the reflective surface (12) is adjustable with respect to the bicycle (1).

10. Bicycle according to claim 1, characterised in that it is a bicycle on which a user has to sit upright or bent forward.

11. Bicycle (1) according to claim 1 characterised in that it is provided with a reflective surface (12) for looking forwards and a reflective surface for looking backwards.

12. The bicycle (1) according to claim 12, wherein the reflective surface is affixed lower than the highest point (5A) of the saddle (5) and to enable a user of the bicycle (1) forwards or backwards via the reflective surface (12).

13. The bicycle (1) according to claim 12, wherein the reflective surface (12) is affixed in a location to enable an user on the bicycle (1) look behind him via the reflective surface (12) and the space between and/or next to his legs.

14. The bicycle (1) according to claim 13, wherein the reflective surface (12) is affixed in front of the saddle (5), viewed in the intended riding direction of the bicycle (1), whereby enabling a user to look downwards to look behind him via the reflective surface (12) and the space between or next to his legs.

15. The bicycle (1) according to claim 11, wherein the bicycle (1) is provided with handlebars (4), whereby the reflective surface (12) is affixed at a position behind the handlebars (4), viewed in the riding direction of the bicycle (1).

16. The bicycle (1) according to claim 12, wherein the bicycle (1) is provided with a frame (2) with a bar (8) that slopes downwards from front to back and the reflective surface (12) is affixed to this bar (8).

17. The bicycle (1) according to claim 12, wherein the bicycle (1) comprises handlebars (4) to which the reflective surface (12) is affixed, whereby the user of the bicycle (1) looks forwards via the reflective surface (12).

18. The bicycle (1) according to claim 12, wherein the reflective surface (12) is affixed centrally on the bicycle (1), viewed from left to right.

19. The bicycle (1) according to claim 12, wherein the reflective surface (12) is convex.

20. (canceled)
